(19) United States
(12) Patent Application Publication
(10) Pub. No.: US 2014/0061026 A1
(43) Pub. Date: Mar. 6, 2014

(54) Finely divided particles of core-shell structure

(71) Applicants: Karlsruher Institut fuer Technologie (KIT), Karlsruhe (DE); BASF SE, Ludwigshafen (DE)

(72) Inventors: Wolfgang Gerlinger, Limburgerhof (DE); Bernd Sachweh, Meckenheim (DE); Michael Woerner, Bretten (DE); Ertan Akguen, Karlsruhe (DE); Stephanie Sigmund, Karlsruhe (DE); Gerhard Kasper, Karlsruhe (DE)

(73) Assignees: Karlsruher Institut fuer Technologie (KIT), Karlsruhe (DE); BASF SE, Ludwigshafen (DE)

(21) Appl. No.: 14/013,749

(22) Filed: Aug. 29, 2013

Related U.S. Application Data
(60) Provisional application No. 61/694,795, filed on Aug. 30, 2012.

(51) Int. Cl. C08K 5/05; C08K 3/08; C08K 3/22; C08K 3/36

(52) U.S. Cl. CPC C08K 5/05; C08K 3/36; C08K 3/08; C08K 3/22
USPC 204/157.71; 204/157.6; 204/157.69

(57) ABSTRACT

The invention provides a process for producing finely divided particles of core-shell structure where the shell comprises at least one polymer, said process comprising the steps of: i. providing a first aerosol stream of droplets in a carrier gas stream wherein the droplets comprise at least one monomer and charging droplets of the first aerosol with electric charge; ii. providing a second aerosol stream of solid particles in a carrier gas stream and charging the solid particles of the aerosol with an electric charge opposite to the electric charge on the droplets of the first aerosol stream; iii. mixing the first aerosol stream with the second aerosol stream to form a mixed aerosol stream; iv. initiating a polymerization of the monomers by irradiating this mixed aerosol stream with electromagnetic radiation. The invention also provides the finely divided particles of core-shell structure which are obtainable by this process.

The present invention relates to a process for producing finely divided particles of core-shell structure where the shell comprises at least one polymer. The invention also relates to finely divided particles of core-shell structure which are obtainable by this process.

The controlled formation and structurization of finely divided composited particles, i.e., particles having a multiphasic morphology, especially particles of core-shell structure or core-shell morphology, is of particular interest in order that particles having specific properties may be produced for highly specialized applications in a controlled manner. Coated finely divided particles of core-shell structure are interesting for numerous applications, for example in dye compositions or as catalysts. The polymer coating prevents the agglomeration of the particles, which leads to higher color intensity or improved catalyst performance. In the medical field of application, marker substances are polymer coated in order that deleterious effects of the particles on the organism may be prevented. The polymer coating can furthermore be used to protect the core material from external influences, for example corrosion, oxidation, reduction, water and so on. Properties such as for example the conductivity of coated particles can also be modified. Possibilities here are for instance finely divided particles of core-shell structure as hybrid materials for printed electronics consisting of conducting or semiconducting polymers with conducting or semiconducting inorganic particles. This results in a wide field of utility for finely divided particles of core-shell structure in optical, electronic, chemical, biotechnological and medical systems.

Numerous processes for producing composite particles are known from the prior art. These include more particularly the processes in the liquid phase such as stepwise emulsion polymerization, emulsion polymerization in a suspension of nonpolymerizable particles or in an emulsion of nonpolymerizable droplets, microencapsulation by coacervation and the like and also processes in the gas phase, for example photo-induced or chemically induced gas phase deposition.

B. Zhang et al., J. Nanopart. Res 2008, 10, 173-178, describe the coating of sodium chloride nanoparticles by photoinduced chemical gas phase deposition; A. M. Boies et al., Nanotechnology 2009, 20, 29, 295604, describe the production of inorganic core-shell particles by chemical gas phase deposition.

J. F. Widmann et al., J. Colloid Interface Sci. 1998, 199, 197-205, describe a process whereby an isolated microparticle is captured in an electrodynamic trap and brought into contact with a monomer droplet. The resulting liquid nanoparticle coating is polymerized photochemically.

The prior art processes for producing finely divided composited particles have a number of disadvantages. First, the composite particles are largely very inhomogeneous, i.e., particle size distribution is broad, particle shape is nonuniform or particle composition is nonuniform. Many finely divided composited particles exhibit addition structures only and not a pronounced core-shell morphology. Moreover, only certain particle size ranges are achievable with existing processes, and small particles are only obtainable in many existing processes to a limited extent, if at all.

Existing gas phase processes for producing core-shell particles are usually limited to certain particle-monomer combinations. Liquid phase processes additionally have the disadvantage of using emulsifiers, which are undesired for many applications and frequently cannot be removed. In addition, many existing processes for producing finely divided composited particles are unsuitable for large scale technical use because of their slow throughput rate.

The present invention has for its object to provide a process for producing finely divided core-shell particles which overcomes the disadvantages of the prior art. More particularly, the process shall afford a high throughput, shall eliminate the need to use surface-active substances such as emulsifiers and surfactants, and shall be implementable in respect of a very large number of core and monomer materials.

We have found that this object is achieved, surprisingly, by a process for producing finely divided particles of core-shell structure where the shell comprises at least one polymer when the process comprises the here and hereinbelow more particularly elucidated steps i. to iv. and wherein two oppositely charged streams of aerosol are mixed with each other, the first stream of aerosol comprising polymerizable monomers and the second stream of aerosol comprising solid particles, and then a polymerization is induced photochemically. This gives particles of core-shell structure wherein the core is formed by the particles of the second stream of aerosol and a polymeric shell is formed by the polymerized monomers of the first stream of aerosol.

The invention accordingly provides the here and hereinafter described process comprising the steps of:
i. providing a first aerosol stream of droplets in a carrier gas stream wherein the droplets comprise at least one monomer and charging droplets of the first aerosol with electric charge;
ii. providing a second aerosol stream of solid particles in a carrier gas stream and charging the solid particles of the aerosol with an electric charge opposite to the electric charge on the droplets of the first aerosol stream;
iii. mixing the first aerosol stream with the second aerosol stream to form a mixed aerosol stream;
iv. initiating a polymerization of the monomers by irradiating this mixed aerosol stream with electromagnetic radiation.

Advantages of the process according to the present invention are, first, a high purity for the product, since no surface-active substances such as emulsifiers or surfactants have to be added. Nor is it necessary to add a solvent. Nor is it necessary to add a photoinitiator to the monomers when the particles of the second stream of aerosol act as a photoinitiator or high-energy radiation is used. The process of the present invention affords the simultaneous coating of a multiplicity of particles. The process can be applied to a multiplicity of core particles that are solid, since it is a purely physical process to charge and coagulate oppositely charged droplets and particles. The finely divided core-shell particles obtainable according to the present invention have a particularly uniform core-shell structure. A further advantage of the process according to the present invention is that the like electrostatic charges on the solid particles and droplets prevent particles and droplets coagulating with one another, i.e., within the two streams of aerosol. As a result, the process of the present invention provides a narrower particle size distribution and hence better reproducibility of the core-shell particles obtained.

A further advantage of the process according to the present invention over processes involving thermally induced polymerization is that heating can be dispensed with. The necessary heating during thermally induced polymerization causes some of the monomers to evaporate, so particle diameter and shell thickness adjustment is complicated and often irreproducible and may only result in incomplete coating being achieved. By contrast, using the process of the present invention the thickness of the polymer shell is easy to control in a specific manner by varying the droplet size in the first stream of aerosol and via the ratio of mass flows in the aerosol streams.

A person skilled in the art is able to adjust the structure of the finely divided core-shell particles obtained after the polymerization to the desired result by varying the process parameters such as droplet size for the first stream of aerosol, number of charges on the droplets and/or particles, particle and droplet concentrations, mixing zone geometry and length, residence time in any unilluminated delay zone.

According to the present invention, the particles produced comprise at least one polymer which, for the purposes of the present invention, is to be understood as meaning a homopolymer and/or copolymer. The term “homopolymer” is to be understood as meaning a polymer polymerized from the same monomers. The term “copolymer” is to be understood as meaning a polymer polymerized from two or more different monomers.

In general, the first stream of aerosol in the process of the present invention can utilize any monomer that is polymerizable by exposure to electromagnetic radiation. Olefinically unsaturated monomers are concerned in particular as well as cyclic monomers amenable to a photochemically induced ring-opening polymerization.

The monomers of the first stream of aerosol may be neutral, acidic, basic or cationic for example.

The monomers are preferably selected among olefinically unsaturated monomers, i.e., monomers having at least one, e.g., one, two, three or four, C═C double bonds, in which case particular preference is given to monomers of this type where the C═C double bond is in the form of a vinylic double bond, i.e., a monosubstituted double bond, or a vinylidene double bond, i.e., a disubstituted double bond where the two substituents are attached to the same carbon atom involved in the C═C double bond. Preference is given especially to olefinically unsaturated monomers where the double bond is in conjugation with an unpolymerizable double bond, for example in conjugation with a carbonyl group, a nitrile group or an aromatic ring, for example a benzene ring, imidazole ring or a pyridine ring.

More preferably, the at least one monomer is selected among monoolefinically unsaturated monomers and especially among mixtures of at least one monoolefinically unsaturated monomer with at least one polyolefinically unsaturated monomer.

In a preferred embodiment of the present invention, the first stream of aerosol used in the process of the present invention in addition to the at least one monomer comprises at least one polyolefinically unsaturated monomer (crosslinker).

Polyolefinically unsaturated monomers in the polymerization reaction of the provided monomers are effective in crosslinking and hence increasing the molecular weight of the polymers obtained. The at least one crosslinker is used for example in an amount of 1 to 80% by weight, preferably of 2 to 20% by weight and more preferably 3 to 15% by weight, all based on the total amount of olefinically unsaturated monomers.

In a further preferred embodiment of the present invention, the at least one monomer used in the first stream of aerosol of the process according to the present invention comprises essentially exclusively at least one polyolefinically unsaturated monomer (crosslinker). In this embodiment, the at least one polyolefinically unsaturated monomer is generally used in an amount of 80 to 100% by weight, preferably in an amount of 90 to 100% by weight and more preferably in an amount of 97 to 100% by weight, all based on the total amount of olefinically unsaturated monomers.

More preferably, at least 90% by weight of the monomers in the aerosol stream are selected among neutral olefinically unsaturated monomers.

Neutral monoolefinically unsaturated monomers suitable for the purposes of the present invention are generally selected among monoolefinically unsaturated C₃-C₆ monocarboxylic acids, monoolefinically unsaturated C₄-C₆ dicarboxylic acids, esters of monoolefinically unsaturated C₃-C₆ monocarboxylic acids, esters of monoolefinically unsaturated C₄-C₆ dicarboxylic acids, amides of monoolefinically unsaturated C₃-C₆ monocarboxylic acids, N-vinylamides, N-vinyllactams, vinylaromatics, vinyl ethers, vinyl, allyl and methallyl esters, monoolefinically unsaturated nitriles, α-olefins, monoolefinically unsaturated sulfonic acids, monoolefinically unsaturated phosphonic acids and monoolefinically unsaturated phosphoric half-esters, especially among neutral monoethylenically unsaturated monomers from the groups of esters of monoolefinically unsaturated C₃-C₆ monocarboxylic acids, esters of monoolefinically unsaturated C₄-C₆ dicarboxylic acids, amides of monoolefinically unsaturated C₃-C₆ monocarboxylic acids, ethylenically unsaturated nitriles, vinyl ethers and mixtures thereof with one or more acidic monomers such as monoolefinically unsaturated C₃-C₆ monocarboxylic acids, monoolefinically unsaturated C₄-C₆ dicarboxylic acids, monoolefinically unsaturated sulfonic acids, monoolefinically unsaturated phosphonic acids and monoolefinically unsaturated phosphoric half-esters.

Examples of neutral monoolefinically unsaturated monomers suitable for the purposes of the present invention are particularly the monomers of the following groups M1 to M12, especially those of groups M1, M2, M4, M6, M7, M8, M9, M10 and M12, specifically those of groups M1, M2, M6, M7, M8, M9 and M10:
M1 esters of monoolefinically unsaturated C₃-C₆ monocarboxylic acids with C₁-C₂₀ alkanols, C₅-C₈ cycloalkanols, phenyl-C₁-C₄-alkanols or phenoxy-C₁-C₄-alkanols, especially the aforementioned esters of acrylic acid and also the aforementioned esters of methacrylic acid, for example methyl acrylate, ethyl acrylate, n-propyl acrylate, isopropyl acrylate, n-butyl acrylate, 2-butyl acrylate, isobutyl acrylate, tert-butyl acrylate, n-hexyl acrylate, 2-ethylhexyl acrylate, 3-propylheptyl acrylate, decyl acrylate, lauryl acrylate, stearyl acrylate, cyclohexyl acrylate, benzyl acrylate, 2-phenylethyl acrylate, 1-phenylethyl acrylate, 2-phenoxyethyl acrylate, and also the esters of methacrylic acid such as methyl methacrylate, ethyl methacrylate, n-propyl methacrylate, isopropyl methacrylate, n-butyl methacrylate, 2-butyl methacrylate, isobutyl methacrylate, tert-butyl methacrylate, n-hexyl methacrylate, 2-ethylhexyl methacrylate, decyl methacrylate, lauryl methacrylate, stearyl methacrylate, cyclohexyl methacrylate, benzyl methacrylate, 2-phenylethyl methacrylate, 1-phenylethyl methacrylate and 2-phenoxyethyl methacrylate;
M2 diesters of monoolefinically unsaturated C₄-C₆ dicarboxylic acids with C₁-C₂₀ alkanols, C₅-C₈ cycloalkanols, phenyl-C₁-C₄-alkanols or phenoxy-C₁-C₄-alkanols, especially the aforementioned diesters of maleic acid and the diesters of fumaric acid, especially di-C₁-C₂₀-alkyl maleates and di-C₁-C₂₀-alkyl fumarates such as dimethyl maleate, diethyl maleate, di-n-butyl maleate, dimethyl fumarate, diethyl fumarate and di-n-butyl fumarate;
M3 vinylaromatic hydrocarbons, for example styrene, vinyltoluenes, tert-butylstyrene, α-methylstyrene and the like, especially styrene;
M4 vinyl, allyl and methallyl esters of saturated aliphatic C₂-C₁₈ monocarboxylic acids, for example vinyl acetate, vinyl propionate, vinyl butyrate, vinyl pivalate, vinyl hexanoate, vinyl 2-ethylhexanoate, vinyl laurate and vinyl stearate and also the corresponding allyl and methallyl esters, and
M5 α-olefins of 2 to 20 carbon atoms and cycloolefins of 5 to 10 carbon atoms such as ethene, propene, 1-butene, isobutene, 1-pentene, cyclopentene, cyclohexene and cycloheptene;
M6 esters of monoolefinically unsaturated C₃-C₆ monocarboxylic acids with polyether monools, especially with C₁-C₂₀-alkyl poly-C₂-C₄-alkylene glycols, specifically with C₁-C₂₀-alkyl polyethylene glycols, wherein the alkyl polyalkylene glycol moiety typically has a molecular weight in the range from 200 to 5000 g/mol (number average), especially the aforementioned esters of acrylic acid and also the aforementioned esters of methacrylic acid;
M7 monoolefinically unsaturated nitriles such as acrylonitrile or methacrylonitrile,
M8 amides of the aforementioned monoolefinically unsaturated C₃-C₈ monocarboxylic acids, especially acrylamide and methacrylamide,
M9 N—(C₁-C₂₀-alkyl)amides and N,N-di-(C₁-C₂₀-alkyl)amides of the aforementioned monoolefinically unsaturated C₃-C₈ monocarboxylic acids;
M10 hydroxyalkyl esters of the aforementioned monoolefinically unsaturated C₃-C₈ monocarboxylic acids, e.g., hydroxyethyl acrylate, hydroxyethylmethacrylate, 2-hydroxypropyl acrylate, 3-hydroxypropyl acrylate, 2-hydroxypropyl methacrylate and 3-hydroxypropyl methacrylate;
M11 N-vinylamides of aliphatic C₁-C₁₀ carboxylic acids and N-vinyllactams such as N-vinylformamide, N-vinylacetamide, N-vinylpyrrolidone and N-vinylcaprolactam;
M12 vinyl ethers of C₁-C₂₀ alkanols such as methyl vinyl ether, ethyl vinyl ether, isobutyl vinyl ether, benzyl vinyl ether.

Examples of acidic monoolefinically unsaturated monomers suitable for the purposes of the present invention are particularly the monomers of the following groups M13 to M17:
M13 monoolefinically unsaturated C₃-C₆ monocarboxylic acids such as acrylic acid, methacrylic acid, vinylpropionic acid and ethacrylic acid and monoolefinically unsaturated C₄-C₆ dicarboxylic acids such as itaconic acid, maleic acid, fumaric acid and citraconic acid and also anhydrides thereof;
M14 monoolefinically unsaturated sulfonic acids where the sulfonic acid group is attached to an aliphatic hydrocarbon moiety, and salts thereof, such as vinylsulfonic acid, allylsulfonic acid, methallylsulfonic acid, 2-acrylamido-2-methylpropanesulfonic acid, 2-methacrylamido-2-methylpropanesulfonic acid, 2-acrylamidoethanesulfonic acid, 2-methacrylamidoethanesulfonic acid, 2-acryloyloxyethanesulfonic acid, 2-methacryloyloxyethanesulfonic acid, 3-acryloyloxypropanesulfonic acid and 2-methacryloyloxypropanesulfonic acid and salts thereof,
M15 vinylaromatic sulfonic acids, i.e., monoolefinically unsaturated sulfonic acids where the sulfonic acid group is attached to an aromatic hydrocarbon moiety, especially to a phenyl ring, and salts thereof, for example styrenesulfonic acids such as 2-, 3- or 4-vinylbenzenesulfonic acid and salts thereof,
M16 monoolefinically unsaturated phosphonic acids where the phosphonic acid group is attached to an aliphatic hydrocarbon moiety, and salts thereof, such as vinylphosphonic acid, 2-acrylamido-2-methylpropanephosphonic acid, 2-methacrylamido-2-methylpropanephosphonic acid, 2-acrylamidoethanephosphonic acid, 2-methacrylamidoethanephosphonic acid, 2-acryloyloxyethanephosphonic acid, 2-methacryloyloxyethanephosphonic acid, 3-acryloyloxypropanephosphonic acid and 2-methacryloyloxypropanephosphonic acid and salts thereof,
M17 monoolefinically unsaturated phosphoric half-esters, especially the half-esters of phosphoric acid with hydroxy-C₂-C₄-alkyl acrylates and hydroxy-C₂-C₄-alkyl methacrylates such as, for example, 2-acryloyloxyethyl phosphate, 2-methacryloyloxyethyl phosphate, 3-acryloyloxypropyl phosphate, 3-methacryloyloxypropyl phosphate, 4-acryloyloxybutyl phosphate and 4-methacryloyloxybutyl phosphate and salts thereof.

The monomers of the following groups M18 to M21 are examples of basic and cationic monoolefinically unsaturated monomers useful in the first aerosol stream of the process according to the present invention:
M18 vinylheterocycles such as 2-vinylpyridine, 3-vinylpyridine, 4-vinylpyridine and N-vinylimidazole;
M19 quaternized vinylheterocycles such as 1-methyl-2-vinylpyridinium salts, 1-methyl-2-vinylpyridinium salts, 1-methyl-4-vinylpyridinium salts, and N-methyl-N′-vinylimidazolium salts, for example the chlorides or methosulfates;
M20 N,N-(di-C₁-C₁₀-alkylamino)-C₂-C₄-alkylamides and N,N-(di-C₁-C₁₀-alkylamino)-C₂-C₄-alkyl esters of the aforementioned monoolefinically unsaturated C₃-C₈ monocarboxylic acids, e.g., 2-(N,N-dimethylamino)ethylacrylamide, 2-(N,N-dimethylamino)ethylmethacrylamide, 2-(N,N-dimethylamino)propylacrylamide, 2-(N,N-dimethylamino)propylmethacrylamide, 3-(N,N-dimethylamino)propyl-acrylamide, 3-(N,N-dimethylamino)propylmethacrylamide, 2-(N,N-diethylamino)-ethylacrylamide, 2-(N,N-diethylamino)ethylmethacrylamide, 2-(N,N-diethyl-amino)propylacrylamide, 2-(N,N-diethylamino)propylmethacrylamide, 3-(N,N-diethylamino)propylacrylamide, 3-(N,N-diethylamino)propylmethacrylamide, 2-(N,N-dimethylamino)ethyl acrylate, 2-(N,N-dimethylamino)ethyl methacrylate, 2-(N,N-dimethylamino)propyl acrylate, 2-(N,N-dimethylamino)propyl methacrylate, 3-(N,N-dimethylamino)propyl acrylate, 3-(N,N-dimethylamino)-propyl methacrylate, 2-(N,N-diethylamino)ethyl acrylate, 2-(N,N-diethylamino)-ethyl methacrylate, 2-(N,N-diethylamino)propyl acrylate, 2-(N,N-diethylamino)-propyl methacrylate, 3-(N,N-diethylamino)propyl acrylate and 3-(N,N-diethyl-amino)propyl methacrylate;
M21N,N-(tri-C₁-C₁₀-alkylammonium)-C₂-C₄-alkylamides and N,N-(tri-C₁-C₁₀-alkyl-ammonium)-C₂-C₄-alkyl esters of the aforementioned monoolefinically unsaturated C₃-C₈ monocarboxylic acids, e.g., 2-(N,N,N-trimethylammonium)ethylacrylamide, 2-(N,N,N-trimethylammonium)ethylmethacrylamide, 2-(N,N,N-trimethyl-ammonium)propylacrylamide, 2-(N,N,N-trimethylammonium)propyl-methacrylamide, 3-(N,N,N-trimethylammonium)propylacrylamide, 3-(N,N,N-trimethylammonium)propylmethacrylamide, 2-(N,N,N-triethylammonium)ethyl-acrylamide, 2-(N,N,N-triethylammonium)ethylmethacrylamide, 2-(N,N,N-triethyl-ammonium)propylacrylamide, 2-(N,N,N-triethylammonium)propylmethacrylamide, 3-(N,N,N-triethylammonium)propylacrylamide, 3-(N,N,N-triethylammonium)-propylmethacrylamide, 2-(N,N,N-trimethylammonium)ethyl acrylate, 2-(N,N,N-trimethylammonium)ethyl methacrylate, 2-(N,N,N-trimethylammonium)propyl acrylate, 2-(N,N,N-trimethylammonium)propyl methacrylate, 3-(N,N,N-trimethylammonium)propyl acrylate, 3-(N,N,N-trimethylammonium)propyl methacrylate, 2-(N,N,N-triethylammonium)ethyl acrylate, 2-(N,N,N-triethylammonium)ethyl methacrylate, 2-(N,N,N-triethylammonium)propyl acrylate, 2-(N,N,N-triethylammonium)propyl methacrylate, 3-(N,N,N-triethylammonium)propyl acrylate and 3-(N,N,N-triethylammonium)propyl methacrylate, especially their chlorides, methosulfates and ethosulfates.

Polyolefinically unsaturated compounds (crosslinkers) include for example divinyl-benzenes, diesters and triesters of olefinically unsaturated carboxylic acids, especially the bis- and trisacrylates of diols or polyols having 3 or more OH groups, for example the bisacrylates and the bismethacrylates of ethylene glycol, diethylene glycol, triethylene glycol, neopentyl glycol or polyethylene glycols, 1,6-hexanediol diacrylate (HDDA), allyl methacrylate (AMA) and trimethylolpropane trimethacrylate (PMPTMA).

Useful monomers of the process of the present invention further include saturated cyclic compounds capable of being polymerized by a photochemically initiated ring-opening polymerization. Examples of monomers of this type are cyclic ethers, for example epoxides, oxetanes, furans and cyclic acetals, and also lactones and lactams.

Examples of epoxides are ethylene oxide, propylene oxide, butylene oxide and styrene oxide.

Examples of cyclic ethers also include cyclic acetals, for example substituted or unsubstituted cyclic acetals having a ring size of 5 or 6 carbon atoms, which are derived from aldehydes having generally from 1 to 10 carbon atoms. This includes particularly trioxane, 1,3-dioxane and 1,3-dioxolane.

Examples of cyclic ethers also include substituted or unsubstituted cyclic monoethers having a ring size of 4 or 5 atoms (oxetanes and furans), which generally have from 3 to 10 carbon atoms, e.g., oxetane, 3,3-dimethyloxetane, tetrahydrofuran, 3-methyltetrahydrofuran, 3,3-dimethyltetrahydrofuran or 3,4-dimethyltetrahydrofuran.

Lactones suitable for the purposes of the present invention include for example substituted or unsubstituted lactones having a ring size of 4, 5, 6 or 7 atoms and having generally from 3 to 10 carbon atoms, e.g., β-propiolactone, γ-butyrolactone, δ-valerolactone and ε-caprolactone.

Lactams suitable for the purposes of the present invention include for example substituted or unsubstituted lactams having a ring size of 4, 5, 6 or 7 atoms and having in general from 3 to 10 carbon atoms, e.g., β-propiolactam, γ-butyrolactam, δ-valerolactam and ε-caprolactam.

The at least one monomer is specifically selected among acrylic acid, n-butyl acrylate, benzyl acrylate, 1,6-hexanediol diacrylate, 1,4-butanediol diacrylate, diethylene glycol diacrylate, triethylene glycol diacrylate, hydroxyethyl methacrylate (HEMA), 2-hydroxypropyl methacrylate (HPMA), C₁-C₂₀-alkyl 2-cyanoacrylates such as ethyl cyanoacrylate (ECA), methacrylic acid, methyl methacrylate (MMA), n-butyl methacrylate, benzyl methacrylate, styrene, α-methylstyrene, 4-vinylpyridine, vinyl chloride, methyl vinyl ether, N-isopropylacrylamide (NIPAM), acrylamide, methacrylamide and mixtures thereof.

In one embodiment of the present invention, the droplets of the first stream of aerosol further comprise at least one nonpolymerizable additive. This additive has the purpose, for example, to modulate the physical, chemical or mechanical properties of the aerosol droplets, for example solution properties of monomers and polymers, surface tension, vapor pressure, droplet stability/viscosity, to thereby modify the properties of the particles, for example the particle structure, especially the shell morphology, or the chemical properties of the shell, in a specific manner.

In principle, any additive can be used that, under the conditions of a photo-polymerization, is not polymerizable and does not inhibit the polymerization of the monomers. It is an essential requirement of the optional additive that it does not absorb the entire radiation made available when the mixed stream of aerosol is irradiated with electromagnetic radiation, preferably UV radiation. The additive referred to is preferably in particulate or dissolved form. A person skilled in the art will be aware of suitable additives in principle and will select the additive with reference to the property profile desired for the polymer shell. The additive may be liquid or solid.

Examples of additives are special-effect organics or inorganics, organic or inorganic actives, for example pharmaceutical, biological, insecticidal, pesticidal actives, solvents, oils, polymers and the like.

The amount in which the at least one additive is used for the purposes of the present invention is generally in the range from 0.1 to 40% by weight, preferably in the range from 0.2 to 30% by weight and more preferably in the range from 0.5 to 25% by weight, all based on the amount of the at least one monomer. The additive quantity may also be larger in the case of solvents.

When the solid additives referred to are added, the finely divided particles of core-shell structure which are obtained are hybridic in that they comprise at least one polymer and/or copolymer and at least one additive.

In one preferable embodiment, the optional additives are metals or oxides of metals and/or semimetals, for example selected among ZnO, TiO₂, Fe oxides such as FeO, Fe₂O₃ and Fe₃O₄, boric acid and borates, aluminum oxide, silicates, aluminosilicates, SiO₂ and mixtures thereof. Additives of this type are present in the monomers as a particulate solid. In one more preferable embodiment, the at least one additive, especially the oxide of the metal and/or semimetal, is in nanoparticulate form, i.e., has a diameter of 1 to 250 nm, preferably 5 to 100 nm and especially 10 to 50 nm. The nanoparticles may have any shape, for example sphere shaped, cube shaped, rod shaped.

In one embodiment of the present invention, at least one solvent is added to the first stream of aerosol. Preferred solvents are solvents in which the at least one monomer is soluble but the polymer formed is insoluble.

Examples of solvents preferred according to the present invention are polar organic solvents such as alcohols, ketones, esters of carboxylic acids or mixtures thereof or polar aprotic organic solvents such as acetonitrile. Further possible solvents are aliphatic and cycloaliphatic hydrocarbons such as hexane, cyclohexane, methylcyclo-hexane, cyclic ethers such as tetrahydrofuran, dioxane and ionic liquids. Mixtures of the solvents mentioned can also be used.

Suitable alcohols include for example methanol, ethanol, propanols, such as n-propanol, isopropanol, butanols, such as n-butanol, isobutanol, tert-butanol, pentanols, glycerol, glycol and mixtures thereof. Suitable ketones include for example acetone, methyl ethyl ketone and mixtures thereof. Suitable esters of carboxylic acids include for example ethyl acetate, methyl acetate, butyl acetate and propyl acetate and mixtures thereof. It is particularly preferable to use ethanol or 1-propanol (n-propanol) as solvent.

When a solvent or solvent mixture is used, the amount of solvent is generally in the range from 10 to 80% by volume, preferably in the range from 30 to 70% by volume and more preferably in the range from 40 to 60% by volume, all based on the amount of the at least one monomer.

Suitable additives also include polymers and oils, for example polyethylene glycol, ethylene oxide-propylene oxide copolymers (EO-PO copolymers), silicone oils and mixtures thereof.

Step iv of the process according to the present invention subjects the monomers in the first stream of aerosol to a polymerization triggered by exposure to electromagnetic radiation. Depending on the wavelength used for the electromagnetic radiation, the optionally used additives and the material in the second stream of aerosol, at least one photoinitiator will be added to the monomers to initiate the polymers.

When at least one photoinitiator is used in the process of the present invention, it will typically be added to the monomer droplets of the first stream of aerosol. Any photoinitiator known to a person skilled in the art as capable of effecting a free-radical or ionic, i.e., cationic or anionic, polymerization reaction of the at least one monomer used on irradiation with electromagnetic radiation is suitable for this in principle. Since the monomer mixture is irradiated with electromagnetic radiation for polymerization, it is preferable for the purposes of the present invention to use photoinitiators which on irradiation with electromagnetic radiation release a sufficiently large amount of (primary) free radicals or, as the case may be, cations or anions.

For the purposes of the present invention, electromagnetic radiation is to be understood as meaning electromagnetic radiation suitable for initiating a polymerization of the at least one monomer in the temperature range of the process according to the present invention, optionally using a photoinitiator. The electromagnetic radiation may comprise x-rays or gamma rays for example. Preferably, the electromagnetic radiation used for the purposes of the present invention comprises UV radiation or visible light, i.e., electromagnetic radiation having a wavelength of 150 to 800 nm, preferably 180 to 500 nm, more preferably 200 to 400 nm, and especially 250 to 350 nm. It is particularly preferable to use UV radiation, i.e., light having a wavelength of not more than 400 nm, e.g., light having wavelengths in the range from 200 to 400 nm and especially in the range from 250 to 350 nm.

In one embodiment of the present invention, the droplets of the first stream of aerosol consist essentially exclusively of the at least one monomer and at least one photoinitiator, i.e., the concentration of the at least one monomer and of the at least one photoinitiator is in the range from 80 to 100% by weight, preferably in the range from 90 to 100% by weight and especially in the range from 95 to 100% by weight, based on the total mass of droplets.

Examples of preferred photoinitiators for a free-radical polymerization are 2-methyl-1[4-(methylthio)phenyl]-2-morpholinopropan-1-one (obtainable for example under the brand name Irgacure® 907 from BASF SE), 2,2′-azobisisobutyronitrile (AIBN) and further, asymmetrical azo derivatives, benzoin, benzoin alkyl ether, benzoin derivatives, acetophenones, benzil ketals, α-hydroxyalkylphenones, α-aminoalkylphenones, O-acyl-α-oximinoketones, (bi)acylphosphine oxides, thioxanthone (derivatives) and mixtures thereof.

Examples of preferred photoinitiators for a cationic photopolymerization are selected among substituted diaryliodonium salts, substituted triarylphosphonium salts and mixtures thereof.

Examples of preferred photoinitiators for an anionic photopolymerization are selected among transition metal complexes, N-alkoxypyridinium salts, N-phenylacylpyridinium salts and mixtures thereof.

A so-called living anionic polymerization in the purely polymeric batch can also be carried out, optionally comprising a secondary functionalization using terminating reagent, for example by jetting a gaseous or vaporizable chemical compound into the aerosol space, preferably into the unilluminated delay zone.

In the embodiment utilizing at least one photoinitiator, the amount of photoinitiator in the droplets of the first stream of aerosol is for example in the range from 0.1 to 10% by weight, preferably in the range from 0.5 to 8% by weight and more preferably in the range from 0.8 to 5% by weight, all based on the amount of the at least one monomer present.

In one preferable embodiment of the present invention, no photoinitiator is added to the first stream of aerosol, i.e., the concentration of photoinitiator in the first stream of aerosol is less than 0.01% by weight, based on the total mass of droplets. This embodiment comes into consideration for example when the solid particles of the second stream of aerosol, for example ZnO and/or TiO₂, are capable of initiating the photopolymerization in step iv. Alternatively, the photopolymerization in this embodiment can also be triggered using high-energy radiation, for example x-rays or gamma rays.

Any desired solid particles can generally be used in the second stream of aerosol in the context of the present invention. Solid organic, organometallic and inorganic compounds or metals, semimetals and nonmetals may be concerned here. Preferably, the solid particles are selected among oxides, sulfides, carbides, nitrides, carbonates, phosphates and halides of metals or of semimetals, metal carbonyls, elemental metals, elemental semimetals and metal alloys. Examples are elemental metals such as Cu, Ag, Au, Pd, Pt and oxides of semimetal or metal, sulfides, nitrides and carbides, such as SiO₂, SiC, BN, silicates, aluminosilicates, ZnO, ZnS, TiO₂, Al₂O₃, metal halides such as NaCl, tungsten oxides such as WO₂, WO₃ and W₂O₃.

The particles used in the second stream of aerosol are naturally finely divided particles which preferably have a number-average particle diameter in the range from 20 nm to 30 μm, frequently in the range from 25 nm to 10 μm, especially in the range from 30 nm to 1 μm and specifically in the range from 40 to 500 nm. The particle size distribution is preferably monomodal, i.e., the distribution curve has only one maximum. Distribution spread is preferably not very wide. More particularly, finely divided particles having a narrow spread of distribution are used, especially those where the distribution spread Q has values in the range from 1.0 to 1.2:

Q=(D₉₀−D₁₀)/D₅₀

D₅₀ is the median particle diameter,
D₉₀ is the particle diameter than which 90% of the particles are smaller, and
D₁₀ is the particle diameter than which 10% of the particles are smaller.

The particle diameters indicated here and hereinbelow relate to the particle masses determined using a differential mobility analyzer and the particle diameters computed therefrom assuming spherical particles.

The first and second streams of aerosol may generally be provided by any process known to a person skilled in the art, and/or by using suitable carrier gases and devices which are common general knowledge among those skilled in the art. The aerosol streams are more preferably provided in a nebulizer or atomizer using a one- or multi-material nozzle or using an electrospray or using an ultrasonic nebulizer. When the aerosol streams are produced using nozzles, the nozzles for producing the first and second streams of aerosol generally each have an inlet pressure of 1 to 10 bar, especially 1 to 3 bar.

A suitable choice of atomizer and also of its operating conditions, or classification using a differential mobility analyzer (DMA) for example, further enables achieving particularly narrowly distributed droplet or particle size distributions.

The carrier gas stream used to produce the first and second streams of aerosol may be an inert gas stream, for example selected among nitrogen (N₂), carbon dioxide (CO₂), argon (Ar), helium (He) and mixtures thereof, or air or mixtures with air such as lean air for example. When the polymerization is photoinitiated and conducted free-radically, the use of an inert gas stream is preferable. When the polymerization is initiated and conducted cationically, the use of an air or inert gas stream is preferable. The carrier gas stream is preferably an inert gas stream. More particularly, N₂ (nitrogen) is used to form the inert gas stream. This nitrogen can come from any source known to a person skilled in the art, for example from commercially available stock reservoir bottles, from the distillation of air, etc. The other inert gases mentioned can likewise come from sources known to a person skilled in the art. When air is used, it is preferable to use ambient air or compressed air.

The pressure in the carrier gas stream for the purposes of the present invention is preferably equal to atmospheric pressure or slightly elevated atmospheric pressure. For the purposes of the present invention, “slightly elevated atmospheric pressure” is to be understood as meaning a pressure which is from 1 to 500 mbar above atmospheric pressure for example. This preferably slightly elevated pressure has the particular purpose of assisting the carrier gas stream in overcoming the resistance of downstream parts of the apparatus, as of a filter or of a collecting liquid for example.

The first stream of aerosol comprises droplets in a carrier gas stream which comprise the at least one monomer. The process of the present invention is generally conducted such that droplet density in the carrier gas stream is in the range from 10⁴ to 10¹⁰ droplets per cm³, preferably in the range from 10⁶ to 10⁸ droplets per cm³ and most preferably in the range from 10⁷ to 10⁸ droplets per cm³. Droplet density can be determined using a scanning mobility particle sizer (SMPS) or a condensation particle counter for example.

The amount introduced into the carrier gas stream of at least one monomer and optionally at least one photoinitiator and optionally at least one nonpolymerizable additive is determined for the purposes of the present invention such that an appropriate number of particles per volume is obtained. The amount of at least one monomer can be used to compute the size of droplets of liquid formed in the aerosol and hence the size of the finely divided particles obtained after the polymerization.

The number-average droplet diameter is generally chosen such that it is in the range from 20 nm to 30 μm, frequently in the range from 25 to 5000 nm, especially in the range from 30 nm to 1000 nm and specifically in the range from 30 to 500 nm. Droplet diameter is typically set by the choice of operating conditions for the atomizer, for example by the inlet pressure for the atomizer, the ratio of gas flow to liquid flow, etc. In the electrospray process, for example, voltage can be varied, while in the case of an ultrasonic nebulizer the energy input can be varied. In addition, a certain size fraction can be selected via a DMA.

To provide the second stream of aerosol, a suspension of solid particles is typically converted into an aerosol stream using a gas. The suspension used for providing the second stream of aerosol generally has a solids content of 0.01 to 10 mg/mL and preferably of 0.1 to 3 mg/mL. A multiplicity of liquids can be used as liquid suspension medium, preferably liquids which have an atmospheric pressure boiling point in the range from 30 to 120° C. and especially in the range from 40 to 100° C. Preferred liquids are polar solvents such as water, alkanols such as methanol, ethanol, n-propanol, isopropanol or else hydrocarbons. Mixtures of various solvents can also be used. Water is used in particular.

The water-laden aerosol obtained for the second stream of aerosol on using water as solvent passes, after it has been produced, through a suitable dryer, for example a diffusion dryer, to remove the solvent, generally water.

In one embodiment, the solid particles can also be atomized using other, mechanical devices such as a brush feeder for example.

It is also possible to produce the solid particles of the second stream of aerosol from the liquid droplets of a previous stream of aerosol. A solution of the material which is later to form the solid particles of the second stream of aerosol, e.g., sodium chloride, in a solvent, e.g., water, is generally prepared for this. This mixture is for example atomized in a two-material nozzle by means of a carrier gas stream such as nitrogen at a nozzle inlet pressure of 1 bar. The aerosol obtained is passed through a dryer, for example diffusion dryer, to remove the solvent, e.g., water, substantially or completely. In this way, the liquid droplets of the previous stream of aerosol are converted into an aerosol stream of solid particles, e.g., nanoscale sodium chloride particles. This aerosol stream of solid particles is preferably used without intermediate isolation as the second stream of aerosol in the process of the present invention.

The second stream of aerosol provided according to the present invention comprises solid particles in a carrier gas stream. The process of the present invention is generally carried out such that particle density in the carrier gas stream is in the range from 10⁴ to 10¹⁰ particles per cm³, preferably in the range from 10⁴ to 10⁸ particles per cm³ and most preferably in the range from 10⁴ to 10⁸ particles per cm³. Particle density can be determined using a scanning mobility particle sizer (SMPS) or a condensation particle counter for example.

According to the present invention, the droplets of the first stream of aerosol and the particles of the second stream of aerosol are given opposite charges before mixing. The droplets of the first stream of aerosol may be given not only a negative charge but also a positive charge. The solid particles of the second stream of aerosol are given whichever is the opposite charge. In one specific embodiment of the present invention, the droplets of the first stream of aerosol are given a negative charge and the particles of the second stream of aerosol are given a positive charge.

To provide the first stream of aerosol comprising charged droplets comprising at least one monomer, an aerosol stream of essentially uncharged droplets comprising at least one monomer is produced and passed through an electric charger to charge up the droplets, for example a corona charger.

The second stream of aerosol is generally provided in a corresponding manner by producing an aerosol stream of essentially uncharged particles and passing it through an electric charger, for example a corona charger, to charge up the droplets. corona chargers are based on the principle of gas discharge due to applying a high voltage. When the voltage is sufficiently high, a gas discharge occurs and a strong electrical field is formed. Depending on the size of particles used, either field charging or diffusion charging can take place. The mechanism of field charging is dominant for particles 1 μm or more in diameter. The ions produced due to the gas discharge move along the field lines. When these field lines end on the particle surface, there is an impact of ions, resulting in a particle charge. In the case of smaller particle diameters (<1 μm), the ions collide with the particles as a result of stochastic movements (diffusion charging). This process continues even after the charger has been left behind. Processing conditions and settings in the charger can be chosen to effect unipolar charging of the particles and droplets in a specific manner and to adjust charge density in the aerosol stream.

The aerosol of the first stream of aerosol is given a unipolar, preferably negative, charge by using the charger.

The aerosol of the second stream of aerosol is given a charge which is likewise unipolar, and opposite to that of the first stream of aerosol, i.e. preferably positive, by using a charger. Useful chargers for the second stream of aerosol, in addition to the corona charger already mentioned, also include UV chargers or chargers with radioactive sources (bipolar chargers). UV chargers offer a further way to generate an aerosol having a unipolar charge. When the high-energy photons collide with an aerosol particles, electrons are emitted and positively charged particles stay behind. This photoeffect is dependent on the material to be charged and also on the wavelength of radiation. The unipolar charging of the particles of the second stream of aerosol can also be accomplished by using a radioactive source such as Kr85 for example. The radioactive decay produces ionizing radiation which generates not only negative but also positive ions. This ion mixture produces a Boltzmann charge distribution centered on 0 charges. Increasing diameter of the aerosol particles increases the probability of multiple charging. Corona chargers are preferred for the unipolar charging of the aerosol of the second stream of aerosol.

Chargers are preferably constructed with a spray electrode on the inside, to which high voltage is applied. The voltage applied to the spray electrode of the charger is preferably 2 to 6 kV and especially 2 to 4 kV for the first stream of aerosol. The voltage applied to the spray electrode of the charger is preferably 2 to 6 kV and especially 3 to 5 kV for the second stream of aerosol.

The mixing ratio of first to second stream of aerosol is generally chosen such that the ratio of the volume flow of the first stream of aerosol to the volume flow of the second stream of aerosol is in the range from 8:1 to 1:8 and especially in the range from 3:1 to 1:3.

In the process of the present invention, the first stream of aerosol comprising droplets comprising at least one monomer, optionally comprising at least one photoinitiator, optionally comprising at least one additive, is mixed with the second stream of aerosol comprising solid particles to obtain a mixed stream of aerosol. Mixing can in principle be effected using measures of the kind known for mixing of gases or aerosol streams, for example by passing the two streams of aerosol into a mixing zone or bringing the two streams of aerosol together in a suitable manner. The mixing zone may be designed as a mixing chamber for example. In this case, the two streams of aerosol will be passed into the mixing chamber and the mixed stream of aerosol is removed from the mixing chamber. The mixing zone can also be designed as a tubular zone, i.e., as a mixing sector. In this case, the two streams of aerosol will be brought together in the tubular zone in a suitable manner, for example by feeding them conjointly into a zone of tubular design, for example via a Y- or T-piece. Mixing within the mixing zone/sector may also be accelerated using internals known to a person skilled in the art such as static mixers for example.

The mixing zone/sector in a preferable embodiment is extended to an unilluminated delay zone. This delay zone promotes the coming together of the differing charged particles to form finely divided core-shell particles which in addition to a solid core further include a liquid shell comprising the monomers. Thereafter, the polymerization of the monomers is then initiated in the polymerization zone, and the shell of the finely divided core-shell particles solidifies. The average residence time of the mixed stream of aerosol in the unilluminated delay zone is preferably in the range from 1 to 500 sec and especially in the range from 10 to 100 sec.

The mixed stream of aerosol thus obtained is subsequently irradiated with electromagnetic radiation, for example with light, preferably UV radiation, or with high-energy radiation, so the monomers present polymerize. The irradiating is naturally effected in a reaction zone, hereinafter also called photoreactor, that is downstream of the mixing zone.

In a further preferred embodiment of the present invention, the mixed stream of aerosol passes for photopolymerization through a throughflow photoreactor. The average residence time of the mixed stream of aerosol in the flowthrough photoreactor is in the range from 1 to 300 sec and especially in the range from 5 to 60 sec.

Irradiating the carrier gas stream with electromagnetic radiation in the manner of the present invention can generally be effected in any apparatus known to a person skilled in the art. UV radiation is preferably used for the purposes of the present invention. It can be produced by any apparatus known to a person skilled in the art, for example LEDs, excimer radiators, for example with xenon chloride (XeCl, 308 nm), xenon fluoride (XeF, 351 nm), krypton fluoride (KrF, 249 nm), krypton chloride (KrCl, 222 nm), argon fluoride (ArF, 193 nm) or Xe₂ (172 nm) as radiation-active medium, for example at 10 mW/cm² on the radiator surface, or with a UV fluorescence tube, for example at 8 mW/cm² on the radiator surface. The use of an excimer radiator is advantageous, since it is dimmable by pulsed operation, for example down to 10 to 100%. This makes optimizing the polymerization process a relatively simple matter.

In a preferred embodiment of the process according to the present invention, the inside wall of the photoreactor is flushed with air, lean air or an inert gas, for example with N₂, Ar, He, CO₂ or mixtures thereof. This has the purpose for example of minimizing wall losses due to polymer film formation.

In a further embodiment of the process according to the present invention, a reactive gas can additionally be injected for secondary functionalization of the finely divided particles formed.

The process of the present invention, especially steps i to iv are generally carried out at a temperature in the range from 0 to 100° C., especially in the range from 10 to 50° C. and specifically in the range from 20 to 30° C.

Therefore, after emerging from the photoreactors which are preferably used for the purposes of the present invention, the polymerization within the finely divided particles will have substantially concluded to obtain corresponding finely divided particles of core-shell structure which have a solid surface and therefore do not undergo any further change in the course of the subsequent process steps, for example removing the finely divided particles formed. The finely divided particles obtained according to the present invention have a core-shell structure, i.e., the core of the finely divided core-shell particles consists of the solid particles of the second stream of aerosol and the shell consists of the polymerized monomers and also optionally of the at least one nonpolymerizable additive of the first stream of aerosol. The finely divided particles obtained according to the present invention have a particularly homogeneous core-shell structure. A further advantage is that the size the droplets and of the size of the solid particles largely predefines the size of the core-shell particles obtained. The droplet size set via the atomizer can thus be used to directly set the resulting particle size and the shell thickness.

In a further process step, the finely divided particles formed can be removed from the carrier gas. Removal can in principle be effected by any process known to a person skilled in the art. In a preferred embodiment, the finely divided particles formed are removed by collection on a filter and in a further preferred embodiment by introduction into a liquid medium. Collection in a liquid can be effected using a wash bottle or a wet electrofilter for example.

The liquid medium which is optionally used for collecting can be selected among water, ethanol, organic solvents, for example apolar solvents of any kind, for example alkanes, cycloalkanes and mixtures thereof. Introducing the finely divided particles produced into the liquid medium gives a suspension of the finely divided particles in the liquid medium. This suspension can be further processed to recover the particles, for example by separating the finely divided particles from the suspension, or this suspension constitutes the process product desired according to the present invention and can be introduced directly into the corresponding use. To ensure long-term survival of the resulting particle sizes, further additives can be added to the core-shell particles to stabilize the particles against agglomeration and thereby avoid agglomeration of the core-shell particles obtained.

The finely divided particles can also be collected with a filter. Suitable filters are known per se to a person skilled in the art, examples being polyamide filters, polycarbonate filters, PTFE filters, with pore sizes of 50 nm for example, electrofilters.

The process of the present invention provides finely divided particles of core-shell structure where the shell comprises at least one polymer and/or copolymer formed from the monomers of the first stream of aerosol. For the purposes of the present invention, the term “finely divided particles” is to be understood as meaning particles that have a number-average particle diameter in the range from 25 nm to 30 μm, frequently in the range from 25 nm to 10 μm, especially in the range from 30 nm to 1 μm and specifically in the range from 40 to 500 nm.

The process of the present invention naturally provides compositions comprising a multiplicity of these finely divided particles. Median particle size and the particle size distribution of the finely divided particles in these compositions are naturally determined by the particle size distribution of the particles of the second stream of aerosol. The particle size distribution is preferably monomodal, i.e., the distribution curve has only one maximum. Distribution spread is preferably not very wide. The process of the present invention is capable of achieving distribution spreads Q having values in the range from 1.0 to 1.2.

The finely divided particles obtainable according to the present invention are novel and likewise form part of the subject matter of the present invention.

The present invention also provides compositions of finely divided particles, for example dispersions of finely divided particles and powders of finely divided particles, wherein the finely divided particles are selected among the finely divided particles of the present invention.

The core of the finely divided particles of core-shell structure is generally formed of a solid organic, inorganic or organometallic material. The core of the core-shell particles generally comprises on average from 1 to 99.9% by volume, especially from 10 to 95% by volume and specifically from 50 to 90% by volume based on the total volume of the particles.

The average molecular weight of the uncrosslinked polymer sheath of core-shell particles can be determined using GPC. The number-average molecular weight of the polymer sheaths is generally in the range from 1000 to 1 000 000 g/mol, frequently 5000 to 100 000 g/mol, especially 10 000 to 80 000 g/mol and specifically 10 000 to 60 000 g/mol.

The process of the present invention can be designed as a batch process or as a continuous process. The process of the present invention is preferably conducted as a continuous operation.

### FIGURE DESCRIPTION

FIGS. 1 and 2 show transmission electron micrographs of a finely divided particle of core-shell structure obtained in Example 1.

FIG. 3 shows a transmission electron micrograph of a finely divided particle of core-shell structure obtained in Example 2.

FIG. 4 shows a transmission electron micrograph of a finely divided particle of core-shell structure obtained in Example 3.

FIG. 5 shows a transmission electron micrograph of a finely divided particle of core-shell structure obtained in Example 4.

FIG. 6 shows a transmission electron micrograph of finely divided particles of core-shell structure obtained in Example 5.

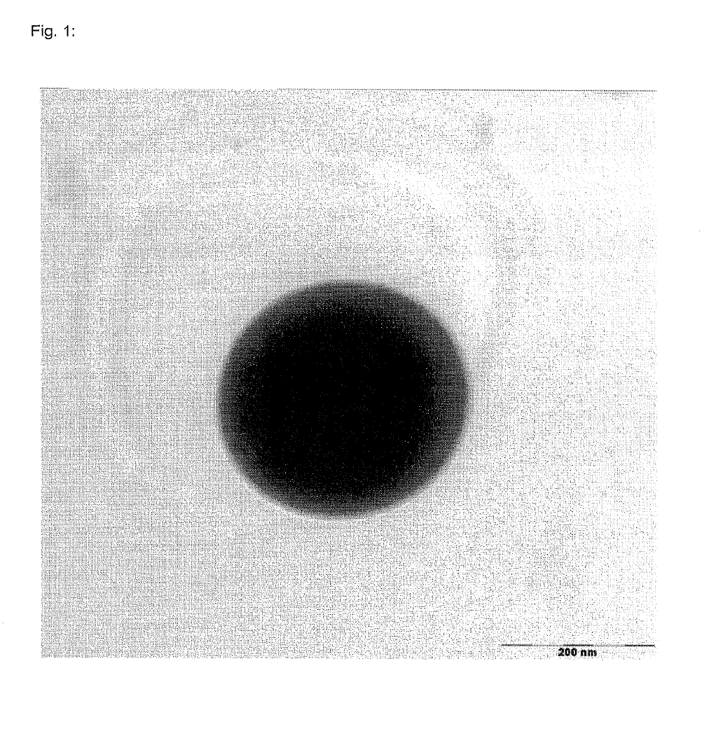

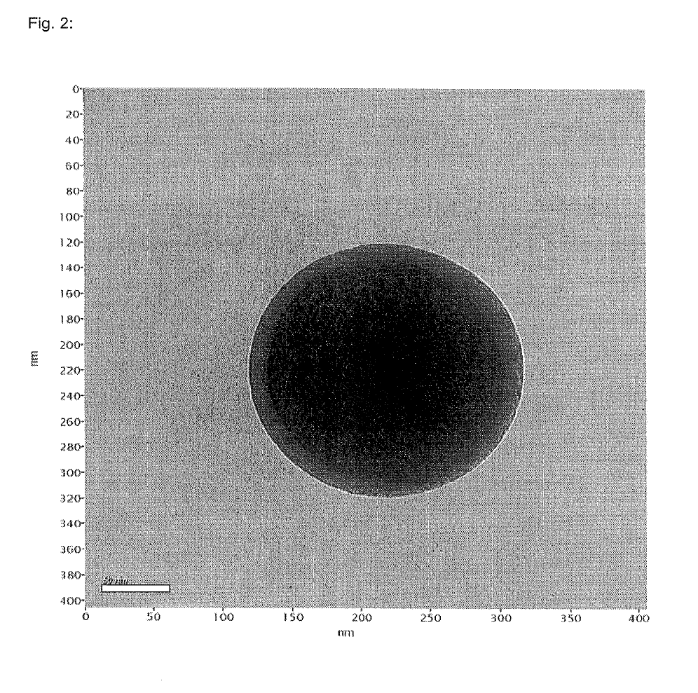

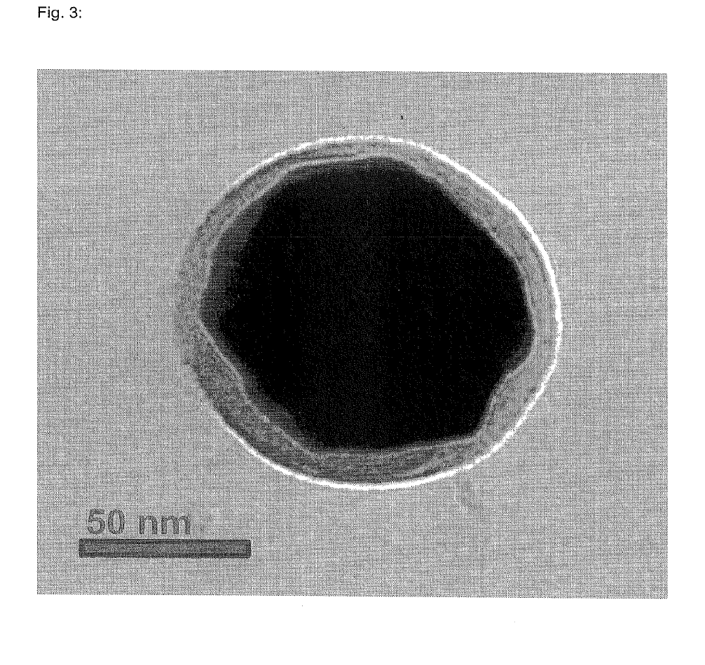

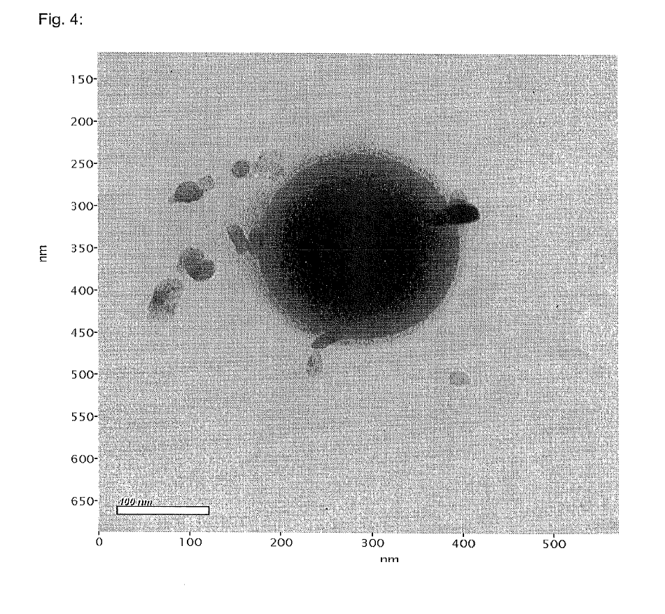

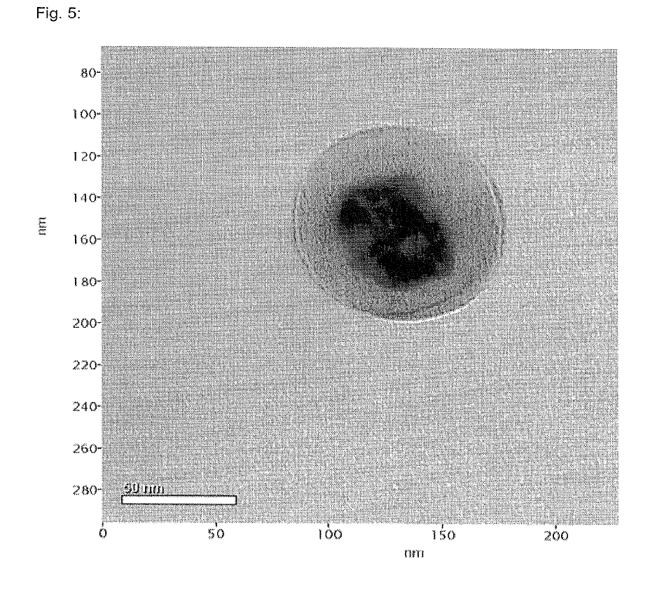

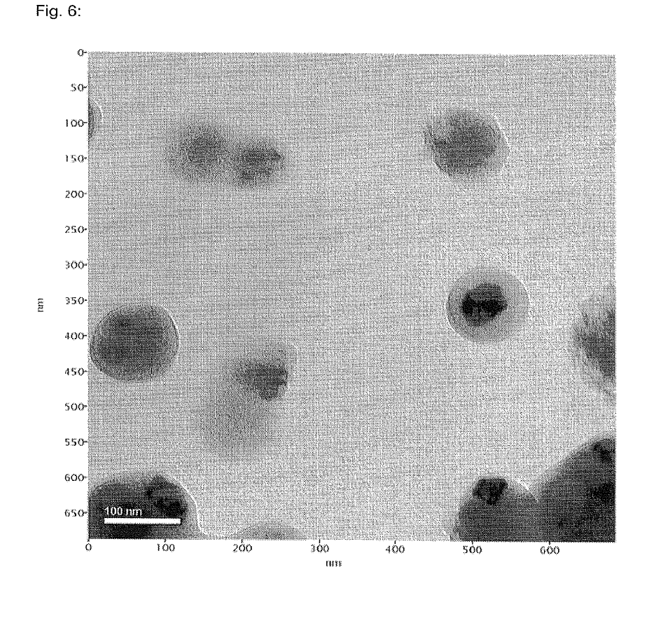

### EXAMPLES

### Analytical Methods:

Transmission electron microscopy (TEM) can be used to visualize the cores and shells of the core-shell particles. Fourier transform infrared spectroscopy (FTIR) is used as spectroscopic method to show that the double bonds of the monomer molecules are absent in the polymer structures, and/or that the liquid monomer layer has become solid polymer. Gel permeation chromatography (GPC) can be used to determine the average molecular weight of the polymer sheath.

### General Experimental Procedure:

To produce the first stream of aerosol, the solution of at least one monomer, optionally at least one photoinitiator, optionally at least one additive and optionally at least one crosslinker is fed by means of the carrier gas stream into an ATM 220 atomizer with two-material nozzle from Topas. After emerging from the atomizer, the aerosol is electrically charged up in a corona charger.

To produce the second stream of aerosol, the suspension of solid particles in, for example, water is fed by means of the carrier gas stream into an ATM 220 atomizer with two-material nozzle from Topas. The aerosol subsequently flows through a DDU 570/H diffusion dryer from Topas to minimize the water content of the aerosol. On emerging from the atomizer, the aerosol is electrically charged up in a corona charger with the opposite charge to the first stream of aerosol.

To produce the second aerosol stream of solid sodium chloride particles in Examples 4 and 5, the second aerosol stream is provided according to the following method: A solution of sodium chloride in water having a solids content of 3.5 mg of sodium chloride per 1 mL of water is prepared. This mixture is atomized in a two-material nozzle at a nozzle inlet pressure of 1 bar by means of the carrier gas stream. The aerosol produced, which consists of water droplets comprising sodium chloride, is passed through a diffusion dryer. On emerging from the diffusion dryer, the second aerosol stream of solid, nanoscale sodium chloride particles is obtained and electrically charged up in a corona charger with the opposite charge to the first stream of aerosol.

The first and second streams of aerosol are brought together and flow through a darkened delay zone. The mixed stream of aerosol then flows through one of the two self-built photoreactors, photoreactor 1 or 2 (photoreactor 1 has a UV source comprising an XeCl excimer radiator with a photon power output of 10 mW/cm² on the radiator surface. The UV radiator in this photoreactor is centered, so irradiation takes place toward the outside. Photoreactor 2 consists of 3 identical UV radiators, each equipped with a UV fluorescence tube and a photon power output of 8 mW/cm² on the radiator surface. In this photoreactor, the UV radiators are outside the reaction volume, so irradiation takes place toward the inside).

Nitrogen (N₂) was used as carrier gas in all examples.

### List of Chemicals Used:

methyl methacrylate n-butyl acrylate
1,6-hexanediol diacrylate
Irgacure® 907 photoinitiator (from BASF SE) (2-methyl-1[4-(methylthio)phenyl]-2-morpholinopropan-1-one)
spherical, nanoscale silicon dioxide, particle diameter 250 nm (from Microparticles) substantially spherical, nanoscale gold, particle diameter 100 nm (from Postnova)
nanoscale zinc oxide: 40% by weight of zinc oxide nanoparticles in ethanol, particle diameter 30 nm (from Sigma Aldrich)
sodium chloride

### Example 1

### First Stream of Aerosol:

Monomer: methyl methacrylate
Photoinitiator: Irgacure® 907, 1% by weight in methyl methacrylate
Crosslinker: 1,6-hexanediol diacrylate, 10% by volume based on the amount of methyl methacrylate
Nozzle inlet pressure: 1 bar
Charging voltage: 2 kV
Polarity of droplets: negative
Concentration of monomer droplets in the aerosol: 10⁷ to 10⁸ droplets/cm³
Mean droplet diameter: 131.4 nm, standard deviation 0.57 μm
Elementary charges per droplet: 10 to 60, depending on the diameter

### Second Stream of Aerosol:

Solid material: spherical, nanoscale silicon dioxide
Concentration: 1 mg of SiO₂ per 1 mL of H₂O
Nozzle inlet pressure: 2 bar
Charging voltage: 4 kV
Polarity of particles: positive
Concentration of particles in the aerosol: 10⁵ particles/cm³
Mean particle diameter: 250 nm, standard deviation 0.1 μm
Elementary charges per particle: 40

### Mixed Stream of Aerosol:

Residence time in unilluminated delay zone: 10 sec
Irradiation time: 3 min
Photoreactor: photoreactor 1

### Example 2

### First Stream of Aerosol:

Monomer: methyl methacrylate
Photoinitiator: Irgacure® 907, 1% by weight in methyl methacrylate
Crosslinker: 1,6-hexanediol diacrylate, 10% by volume, based on the amount of methyl methacrylate
Nozzle inlet pressure: 1 bar
Charging voltage: 2 kV
Polarity of droplets: negative
Concentration of monomer droplets in the aerosol: 10⁷ to 10⁸ droplets/cm³
Mean droplet diameter: 131.4 nm, standard deviation 0.57 μm
Elementary charges per droplet: 10 to 60, depending on the diameter

### Second Stream of Aerosol:

Solid material: approximately spherical, nanoscale gold
Concentration: 0.6 mg of Au per 1 mL of H₂O
Nozzle inlet pressure: 2 bar
Charging voltage: 4 kV
Polarity of particles: positive
Concentration of particles in the aerosol: 10⁵ particles/cm³
Mean particle diameter: 100 nm
Elementary charges per particle: 20

### Mixed Stream of Aerosol:

Residence time in unilluminated delay zone: 10 sec
Irradiation time: 3 min
Photoreactor: photoreactor 2

### Example 3

### First Stream of Aerosol:

Monomer: methyl methacrylate
Photoinitiator: Irgacure® 907, 1% by weight, in methyl methacrylate
Crosslinker: 1,6-hexanediol diacrylate, 10% by volume, based on the amount of methyl methacrylate
Ethanol: 0.2 mL of suspension of zinc oxide nanoparticles in ethanol per 15 ml of methyl methacrylate, this suspension is added to the monomer solution.
Nozzle inlet pressure: 1 bar
Charging voltage: 2 kV
Polarity of droplets: negative
Concentration of monomer droplets in the aerosol: 10⁷ to 10⁸ droplets/cm³
Mean droplet diameter: 131.4 nm, standard deviation 0.57 μm
Elementary charges per droplet: 10 to 60, depending on the diameter

### Second Stream of Aerosol:

Solid material: spherical, nanoscale silicon dioxide
Concentration: 1 mg of SiO₂ per 1 mL of H₂O
Nozzle inlet pressure: 2 bar
Charging voltage: 4 kV
Polarity of particles: positive
Concentration of particles in the aerosol: 10⁵ particles/cm³
Mean particle diameter: 250 nm, standard deviation 0.1 μm
Elementary charges per particle: 40

### Mixed Stream of Aerosol:

Residence time in unilluminated delay zone: 10 sec
Irradiation time: 3 min
Photoreactor: photoreactor 2

### Example 4

### First Stream of Aerosol:

Monomer: methyl methacrylate
Photoinitiator: Irgacure® 907, 1% by weight in methyl methacrylate
Crosslinker: 1,6-hexanediol diacrylate, 10% by volume based on the amount of methyl methacrylate
Nozzle inlet pressure: 1 bar
Charging voltage: 3.5 kV
Polarity of droplets: negative
Concentration of monomer droplets in the aerosol: about 10⁷ droplets/cm³
Mean droplet diameter: about 130 nm
Elementary charges per droplet: about 10 to 60, depending on the diameter

### Second Stream of Aerosol:

Solid material: nanoscale sodium chloride
Nozzle inlet pressure: 2 bar
Charging voltage: 4 kV
Polarity of particles: positive
Concentration of particles in the aerosol: about 10⁷ particles/cm³
Mean particle diameter: about 65 nm
Elementary charges per particle: about 10 to 60, depending on the diameter

### Mixed Stream of Aerosol:

Residence time in unilluminated delay zone: 60 sec
Irradiation time: 3 min
Photoreactor: photoreactor 2

### Example 5

### First Stream of Aerosol:

Monomer: 1,6-hexanediol diacrylate
Photoinitiator: Irgacure® 907, 1% by weight in 1,6-hexanediol diacrylate
Crosslinker:
Nozzle inlet pressure: 1 bar
Charging voltage: 3.5 kV
Polarity of droplets: negative
Concentration of monomer droplets in the aerosol: about 10⁷ droplets/cm³
Mean droplet diameter: about 130 nm
Elementary charges per droplet: about 10 to 60, depending on the diameter

### Second Stream of Aerosol:

Solid material: nanoscale sodium chloride
Nozzle inlet pressure: 2 bar
Charging voltage: 4 kV
Polarity of particles: positive
Concentration of particles in the aerosol: about 10⁷ particles/cm³
Mean particle diameter: about 65 nm
Elementary charges per particle: about 10 to 60, depending on the diameter
Mixed stream of aerosol:
Residence time in unilluminated delay zone: 60 sec
Irradiation time: 3 min
Photoreactor: photoreactor 2

### Example 6

Finely divided particles of core-shell structure were produced similarly to Example 1. Butyl acrylate was used as monomer in the first stream of aerosol. Photoinitiator was used but no crosslinker. The solid material in the second stream of aerosol was spherical, nanoscale silicon dioxide.

The finely divided particles obtained had cores of spherical, nanoscale silicon dioxide and shells of poly(n-butyl acrylate).

Since no crosslinker was added, the shells of the finely divided particles of core-shell structure could not be seen in the transmission electron micrographs.

1-23. (canceled)

24. A process for producing finely divided particles of core-shell structure where the shell comprises at least one polymer, said process comprising the steps of:
i. providing a first aerosol stream of droplets in a carrier gas stream wherein the droplets comprise at least one monomer and charging droplets of the first aerosol with electric charge;
ii. providing a second aerosol stream of solid particles in a carrier gas stream and charging the solid particles of the aerosol with an electric charge opposite to the electric charge on the droplets of the first aerosol stream;
iii. mixing the first aerosol stream with the second aerosol stream to form a mixed aerosol stream;
iv. initiating a polymerization of the monomers by irradiating said mixed aerosol stream with electromagnetic radiation.

25. The process of claim 24, wherein the droplets of the first aerosol stream consist essentially of the at least one monomer and at least one photoinitiator.

26. The process of claim 24, wherein the droplets of the first aerosol stream further comprise at least one nonpolymerizable additive.

27. The process of claim 24, wherein the droplets of the first aerosol stream have a number-average droplet diameter in the range from 20 nm to 30 μm.

28. The process of claim 24, wherein the first aerosol stream has a droplet density in the range from 10⁴ to 10¹⁰ droplets per cm³.

29. The process of claim 24, wherein the at least one monomer is selected from olefinically unsaturated monomers and cyclic ethers, lactones, and lactams.

30. The process of claim 24, wherein the at least one monomer is selected fom monoolefinically unsaturated monomers and mixtures of at least one monoolefinically unsaturated monomer with at least one polyolefinically unsaturated monomer.

31. The process of claim 29, wherein the at least one monomer comprises at least one monoolefinically unsaturated monomer selected among monoolefinically unsaturated C₃-C₆ monocarboxylic acids, monoolefinically unsaturated C₄-C₆ dicarboxylic acids, esters of monoolefinically unsaturated C₃-C₆ monocarboxylic acids, esters of monoolefinically unsaturated C₄-C₆ dicarboxylic acids, amides of monoolefinically unsaturated C₃-C₆ monocarboxylic acids, N-vinylamides, N-vinyllactams, vinylaromatics, vinyl ethers, vinyl, allyl and methallyl esters, monoolefinically unsaturated nitriles, α-olefins, monoolefinically unsaturated sulfonic acids, monoolefinically unsaturated phosphonic acids and monoolefinically unsaturated phosphoric half-esters.

32. The process of claim 24, wherein an aerosol stream of essentially uncharged droplets comprising at least one monomer is produced and passed through an electric charger to charge up the droplets.

33. The process of claim 24, wherein the particles of the stream of aerosol have a number-average particle diameter in the range from 20 nm to 30 μm.

34. The process of claim 24, wherein the second stream of aerosol has a particle density of 10⁴ to 10¹⁰ particles per cm³.

35. The process of claim 24, wherein the particles of the second stream of aerosol consist of at least one solid organic, inorganic or organometallic material.

36. The process of claim 35, wherein the particles of the second stream of aerosol consist of a material selected among oxides, sulfides, carbides, nitrides, carbonates, phosphates and halides of metals or semimetals, metal carbonyls, elemental metals, elemental semimetals and metal alloys.

37. The process of claim 24, wherein the mixed aerosol stream passes through an unilluminated delay zone before being irradiated with electromagnetic radiation.

38. The process of claim 37, wherein the average residence time of the mixed stream of aerosol in the delay zone is in the range from 1 to 500 sec.

39. The process of claim 24, wherein the mixed stream of aerosol passes for polymerization through a throughflow photoreactor.

40. The process of claim 39, wherein the average residence time of the mixed stream of aerosol in the throughflow photoreactor is in the range from 1 to 300 sec.

41. The process of claim 24, wherein photopolymerization is followed by the finely divided particles of core-shell structure being collected on a filter or surface.

42. The process of claim 24, wherein the photopolymerization is followed by the finely divided particles of core-shell structure being collected by introducing the aerosol stream into a liquid medium.

43. Finely divided particles of core-shell structure obtainable by the process of claim 24.

44. The finely divided particles of claim 43 which have a number-average particle diameter in the range from 25 nm to 30 vim.

45. The finely divided particles of claim 43, wherein the core is formed of a solid organic, inorganic, or organometallic material.

46. The finely divided particles of claim 43, wherein the core of the core-shell particles comprises on average from 1 to 99.9% by volume based on the total volume of the particles.
